(19) United States
(12) Patent Application Publication
(10) Pub. No.: US 2012/0284128 A1
(43) Pub. Date: Nov. 8, 2012

(54) ORDER-INDEPENDENT APPROXIMATION FOR ORDER-DEPENDENT LOGIC IN DISPLAY ADVERTISING

(75) Inventors: Xuerui Wang, Sunnyvale, CA (US); Ruofei (Bruce) Zhang, San Jose, CA (US)

(73) Assignee: Yahoo! Inc., Sunnyvale, CA (US)

(21) Appl. No.: 13/102,320

(22) Filed: May 6, 2011

(51) Int. Cl. G06Q 30/00

(52) U.S. Cl. 705/14.71

(57) ABSTRACT

Methods, systems, and apparatuses for forecasting pricing for an advertisement campaign that covers a set of impressions. A dynamic cost per mille (dCPM) value is defined for the campaign. An effective bid price is determined for each of the impressions to generate a plurality of effective bid prices. A parametric distribution is determined based on the plurality of effective bid prices. A mean and a variance are determined for the determined parametric distribution. Bids for the impressions are determined based on the effective bid prices and a participation probability function. The bids are determined in a manner that is independent of an order in which the bids are processed.

### BACKGROUND OF THE INVENTION

1. Field of the Invention

The present invention relates to online advertising, and in particular, to techniques for online advertisement campaign pricing.

2. Background

Online advertisement (“ad”) networks enable display advertisements and/or other types of advertisements to be served to users who visit the Web sites of publishers that are participating in the advertisement network. Advertisers generate the advertisements and buy placements for those advertisements on the publishers' Websites. A placement represents a publisher's agreement to serve a specified advertisement to users when the users visit the publisher's site. The advertisements and placements are typically selected based on the anticipated audiences for those sites. A publisher typically serves the advertisements at the selected placements along with other content associated with the publisher's site.

Each time an advertisement is served to a user, an impression is said to occur. Each impression has attribute values that indicate information regarding the user to whom the advertisement is served and/or the Web site with which the impression is associated. When an advertiser considers buying placements for an advertisement on a publisher's Website, the advertiser often provides a query or contract to the publisher, requesting an advertising supply forecast. The advertising supply forecast is an estimate of a number of impressions, which are to occur in a future time period, that have specified attribute values. The advertiser typically identifies the specified attribute values in the advertiser's query. For instance, the advertiser may want to target users that have particular attributes (e.g., particular ages, locations, interests, etc.) and/or Websites or publishers that have certain attributes.

Display advertising is a form of online advertising where advertisements are displayed alongside online content on web pages. Display advertisements may be displayed in various forms, including in the form of banner ads, etc. Such online advertisements may generate revenue for website providers from advertisers in various forms, including on a cost per click (CPC) basis. For instance, advertisers may purchase online advertisements according to a cost per mille (CPM) factor, which indicates the cost to the advertiser for displaying an advertisement one thousand times.

Display advertising spending has enjoyed a remarkable growth rate, even during an economic downturn. In 2009, the total advertising expenditures in the United States declined by 12.3%. However, online display advertising expenditures increased by 7.3% in 2009. This tremendous growth may be due to various factors, including brand awareness and direct responses. A significant portion of display advertising is sold through online advertisement auctions in the spot market, where the highest paying advertisement of a group of compatible advertisements is served when an impression opportunity occurs. This technique for selling display advertisements is referred to as non-guaranteed delivery (NGD).

In NGD pricing deals, such as a deal using CPM pricing, an advertiser is forced to pay the same amount for every impression. However, not every impression is of equal value to the advertiser. The value of a particular impression to an advertiser may depend on various factors, such as the position of the impression on a web page, attributes of the user viewing the web page, and/or further factors. It is highly inefficient for an advertiser running a $3 fixed CPM campaign to pay $3.00 for an impression that is only worth $2.25 to the advertiser. Dynamic CPM (dCPM) pricing is a form of advertisement pricing that enables advertisers to vary their bid price based on the perceived value of every individual impression and based on their return-on-investment (ROI) goals. dCPM pricing enables improved price efficiency, such that advertisers pay more for high value impressions and less for low value impressions. To perform such pricing, an advertisement server predicts the probability of user response to a particular advertisement, calculates a bid price tied to the value, and determines whether an advertisement creative passes a ROI test. As such, dCPM ensures that the price an advertiser pays for an impression is tied directly to the value of the impression to that advertiser.

Dynamic pricing requires an ROI metric, either a CPC or CPA (cost per action) goal, in order for the ad server to determine a bid price. For example: an advertiser may specify a $0.50 CPC goal for a $3 dCPM campaign. Based on the $0.50 CPC ROI goal and a predicted probability of a user performing the desired action, the advertisement server calculates the value of the impression to that advertiser and assigns a bid price for the auction. Dynamic pricing allows an advertiser to bid different values, such as a bid of $0.25 on a first impression that it values less, and $4.00 on another impression that it values a more, while still maintaining the ROI goal of the advertiser in the aggregate.

Over the life of a dCPM campaign, an advertiser's average effective CPM (eCPM) does not exceed the set dCPM price. Bids over the set price are made only after a reserve is established by previously bidding lower amounts. As such, the order in which impressions are served in conventional dCPM campaigns has a significant impact on final performance metrics for the campaign. However, in many scenarios, such as offline processing and forecasting, it is difficult to exactly maintain the temporal order of impressions because they are often aggregated in some way to alleviate sparsity.

### BRIEF SUMMARY OF THE INVENTION

Various approaches are described herein for, among other things, providing pricing for online advertisement campaigns. Such approaches can approximate conventional order-dependent dCPM pricing without being dependent on an order in which impressions are priced. A participation probability function or profile may be generated for an advertisement campaign based on effective bid prices (e.g., eCPM values) determined for the impressions being targeted by the campaign. Actual bid prices are determined for the impressions targeted by the campaign based on the determined effective bid prices, a dCPM value defined for the campaign, and the participation probability profile. The participation probability profile for the campaign may optionally be modified to ensure that an average effective bid price for the impressions is less than the dCPM value defined for the campaign.

In one implementation, a method is provided for pricing an advertisement campaign that covers a set of impressions. A dCPM value is defined for the campaign. An effective bid price is determined for each of the impressions to generate a plurality of effective bid prices. A parametric distribution is determined based on the plurality of effective bid prices. A mean and a variance are determined for the determined parametric distribution. Bids for the impressions are determined, in an order-independent manner, based on the effective bid prices, the dCPM value, and a participation probability profile generated for the campaign.

In another implementation, an advertisement campaign pricing system is provided. The advertising campaign pricing system includes an effective bid price generator, a parametric distribution generator, and an actual bid generator. The effective bid price generator is configured to determine an effective bid price corresponding to each of a plurality of impressions to generate a plurality of effective bid prices. The parametric distribution generator is configured to determine a parametric distribution based on the plurality of effective bid prices. The determined parametric distribution has a mean and a variance. The actual bid generator is configured to determine bids for impressions of the plurality of impressions in an order-independent manner based on the effective bid prices and a participation probability profile that is based at least on a dCPM value associated with the plurality of impressions, the mean, and the variance.

Computer program products are also described herein that enable advertisement campaign pricing, and that enable further embodiments as described herein.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example advertisement network in accordance with an embodiment described herein.

FIG. 2 shows a block diagram of an advertisement supply forecasting system, according to an example embodiment.

FIG. 3 shows a flowchart for pricing impressions for an advertisement campaign, according to an example embodiment.

FIG. 4 shows a block diagram of an advertisement campaign pricing system, according to an example embodiment.

FIG. 5 shows a block diagram of an effective bid price generator, according to an example embodiment.

FIG. 6 shows a block diagram of parametric distribution generator configured to generate a Gaussian distribution, according to an example embodiment.

FIG. 7 shows a plot of a Gaussian distribution, where effective cost per mille is shown on the x-axis, according to an example embodiment.

FIG. 8 shows a block diagram of an actual bid generator, according to an example embodiment.

FIG. 9 shows a flowchart for determining a bid assignment technique based on a mean value of effective bid prices for impressions of a campaign, according to an example embodiment.

FIG. 10 shows a flowchart for assigning bids to impressions when an average effective bid price for impressions of a campaign is greater than the dynamic cost per mille (dCPM) value of the campaign, according to an example embodiment.

FIG. 11 shows a block diagram of second type of price assigner corresponding to the flowchart of FIG. 10, according to an example embodiment.

FIG. 12 shows a block diagram of a fourth bid price selector configured to modify a participation probability function in the range of [dCPM, 2dCPM] to have a average effective bid price that is less than the dCPM value for the campaign, according to an example embodiment.

FIG. 13 shows a plot of an example of a Gaussian distribution of effective bid prices for an advertisement campaign, where the average value of the effective bid prices is greater than the dCPM value for the campaign, according to an embodiment.

FIG. 14 shows a plot of an auction participation probability function corresponding to the Gaussian distribution of FIG. 13, where the participation probability function is modified in the range of [dCPM, 2dCPM] to have a final average effective bid price that is less than the dCPM value for the campaign, according to an example embodiment.

FIG. 15 shows a block diagram of a second participation probability determiner configured to modify a participation probability function in the range of [dCPM, 2dCPM], depending on a determined threshold value (T), to have a final average effective bid price that is less than the dCPM value for the campaign, according to an example embodiment.

FIG. 16 shows a plot of an example of a Gaussian distribution of effective bid prices for an advertisement campaign, where the average value of the effective bid prices is greater than the dCPM value for the campaign, according to an embodiment.

FIG. 17 shows a plot of an auction participation probability function corresponding to the Gaussian distribution of FIG. 16, where the participation probability function is modified in the ranges of [dCPM, T] and [T, 2dCPM] to have a final average effective bid price that is less than the dCPM value for the campaign, according to an example embodiment.

FIG. 18 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Example embodiments are provided herein for pricing bids on a set of impressions targeted by an advertisement campaign by an advertiser, without regard to an order of the pricing. Such embodiments enable advertisers to estimate their success at bidding on impressions based on various advertisement campaign criteria. Example advertising environments and embodiments for forecasting bids are described in detail in the following sections. It is noted that the embodiments described herein may be adaptable to additional conventional data mining applications where an order of data processing has an impact on the outcome, such as in banking and gaming

### II. Example Online Advertising Environment Embodiments

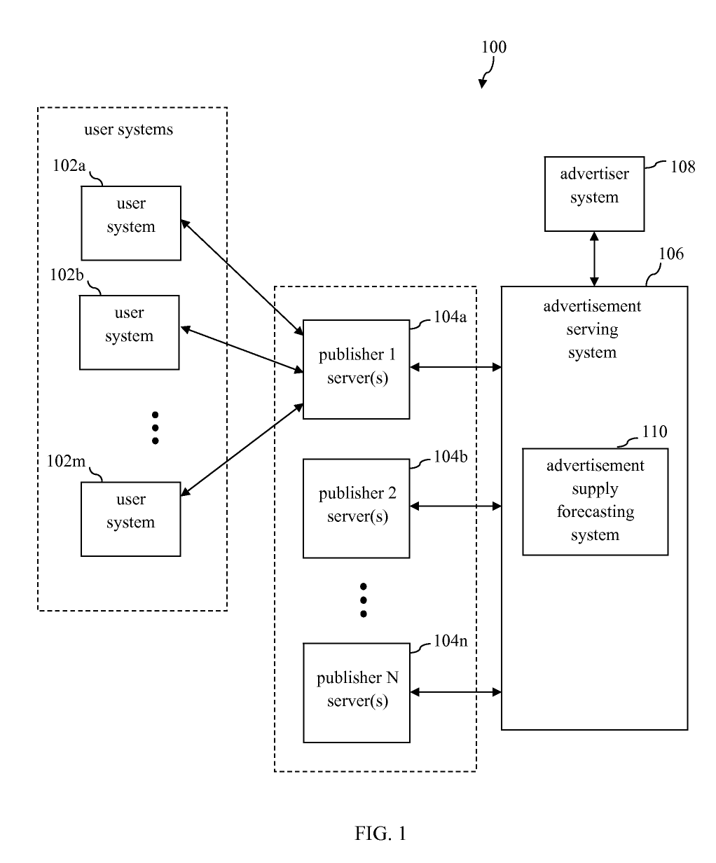

Embodiments for pricing advertisement campaigns may be implemented in a variety of advertising environments. For instance, FIG. 1 shows a block diagram of an example advertisement (“advertisement”) network 100, according to an embodiment. Advertisement network 100 operates to serve advertisements provided by advertisers, such as display advertisements or other types of advertisements, to publisher sites (e.g., Web sites). When such sites are accessed by users of the network, the advertisements are displayed to the users.

As shown in FIG. 1, display advertisement network 100 includes a plurality of user systems 102a-102m, a plurality of publisher servers 104a-104n, an advertisement serving system 106, and at least one advertiser system 108. Communication among user systems 102a-102m, publisher servers 104a-104n, advertisement serving system 106, and advertiser system 108 is carried out over one or more networks using well-known network communication protocols. Example networks include a personal area network (PAN), a local area network (LAN), a wide-area network (WAN), a combination of networks such as the Internet, etc.

User systems 102a-102m are capable of communicating with any one or more of publisher servers 104a-104n in network 100. For example, each of user systems 102a-102m may include a client that enables a user who owns (or otherwise has access to) the user system to access sites (e.g., websites) that are hosted by publisher servers 104a-104n. For instance, a client may include a web browser, a non-web-enabled client, or may be any other suitable type of client. In FIG. 1, each of user systems 102a-102m is shown in FIG. 1 to be communicatively coupled to publisher 1 server(s) 104a to access a site published by publisher 1. Persons skilled in the relevant art(s) will recognize that each of user systems 102a-102m is capable of connecting to any of publisher servers 104a-104n for accessing the sites hosted thereon.

Publisher servers 104a-104n are capable of communicating with user systems 102a-102m in network 100. Each of publisher servers 104a-104n is configured to host a site (e.g., a website) published by a corresponding publisher 1-N so that such site is accessible to users of network 100 via user systems 102a-102m. Each of publisher servers 104a-104n is further configured to serve advertisement(s) to users of network 100 when those users access a website that is hosted by the respective publisher server.

User systems 102a-102m may each be any type of electronic device configured with web browsing functionality (or other suitable network communication functionality), including a desktop computer (e.g., a personal computer, etc.), a mobile computing device (e.g., a personal digital assistant (PDA), a laptop computer, a notebook computer, a tablet computer (e.g., an Apple iPad™), a netbook, etc.), a mobile phone (e.g., a cell phone, a smart phone, etc.), or a mobile email device.

Advertisement serving system 106 may receive advertisements from advertiser system 108 and/or other sources. Advertisement serving system 106 is configured to serve the advertisements to publisher servers 104a-104n when the sites hosted by servers 104a-104n are accessed by users, thereby facilitating the delivery of advertisements to the users. Advertisement serving system 106 may be implemented in various ways, including in the form of one or more computing systems, such as one or more servers.

As shown in FIG. 1, advertisement serving system 106 includes an advertisement supply forecasting system 110. Advertisement supply forecasting system 110 is configured to generate an advertising supply forecast in response to a query, contract, or targeting predicate that indicates particular attribute values, and which is received from an entity in network 100. In response to the contract, advertisement supply forecasting system 110 generates an advertising supply forecast that may include various results, such as an estimate of a number of impressions that are to occur with respect to one or more websites/web pages in a future time period, and that have the attribute values indicated in the contract, based on advertisement campaign criteria. Such advertisement criteria may include a return on investment (ROI) metric, such as a “cost per metric” (e.g., a cost per click (CPC) value or a cost per action (CPA) value), a dynamic cost per mille (dCPM) value, and/or other criteria. The forecast may include further and/or alternative information, including an estimate of bid values for the impressions based on the cost per metric and dCPM value. The contract may be received from any requester, including an advertiser at advertiser system 108 or from another entity. Note that in embodiments, any number of advertiser systems 108 and/or other networked entities may be present in network 100 that are capable of transmitting requests for supply forecasts to advertisement supply forecasting system 110.

Advertisement supply forecasting system 110 is configured to forecast pricing and/or supply of impressions according to the provided information. In one example, system 110 may be configured to perform bid forecasting for a dCPM advertisement campaign for an advertiser, according to conventional techniques. The dCPM campaign may a dCPM value, such as $3.00, which is a maximum cost per mille that the advertiser is willing to pay. The dCPM campaign may also have CPC value goal, such as $0.50. An example procedure for handling an auction for the dCPM campaign for impressions served in an online exchange is shown as follows (a dCPM campaign with a CPA value goal may also be received, and processed in a similar fashion):

(a) Accumlated_Bids = 0; Won_Imps = 0;
(b) Go through each impression:

value = CPC * Prob(click);
Remaining_Balance = Won_Imps * dCPM − Accumlated_Bids;
Bid Actual_Bid = min(value, dCPM + Remaining_Balance,
2dCPM);
If wins:

Won_Imps++;
Accumlated_Bids += Actual_Bid;

According to this process, at (a), values for the variables “Accumulated_Bids” and “Won_Imps” are initialized to zero. (b) is performed for each impression of the campaign. In (b), a “value” variable for a received impression is calculated by multiplying the CPC value goal (e.g., $0.50) by a probability determined for the impression that a user will click on an advertisement of the advertiser displayed for the impression (e.g., a value between 0 and 1). A “Remaining_Balance” variable is calculated by multiplying the Won_Imps variable by the dCPM value (e.g., $3.00), and subtracting the Accumulated_Bids variable from the result. A bid is generated as the “Actual_Bid” variable for the impression that is the minimum one of three possible values−the calculated value variable, a sum of the dCPM value and the Remaining_Balance variable, or two times the dCPM value (2dCPM). If the generated bid is successful, and therefore the value of Actual_Bid is to be paid by the advertiser, the Won_Imps variable is incremented by one, and the value of the Actual_Bid variable is added to the Accumulated_Bids variable. (b) is then repeated for each additional impression of the campaign, which may be hundreds, thousands, or even greater numbers of impressions.

As is apparent from this process, the value of Actual_Bid is bounded with the perceived value of the impression (the value variable), and a value that is based on saved budget from previous impression servings, if any (the sum of dCPM and Remaining_Balance), with the 2dCPM providing an upper-capping factor. The Remaining_Balance variable is highly dependent on the values of previously served impressions. As such, if impressions are served in a different order, the success and/or failure in the winning of bids on impressions may be different. However, it is not always possible to maintain detailed temporal information of large numbers of impressions (e.g., millions, billions, trillions, etc.).

Embodiments of the present invention enable impression supply pricing and/or forecasting to be performed in an order-independent way, while still maintaining the original dCPM pricing value and maintaining an average bid to be less than or equal to the specified dCPM price. Examples of such embodiments are described as follows.

### III. Example Supply Forecasting Embodiments

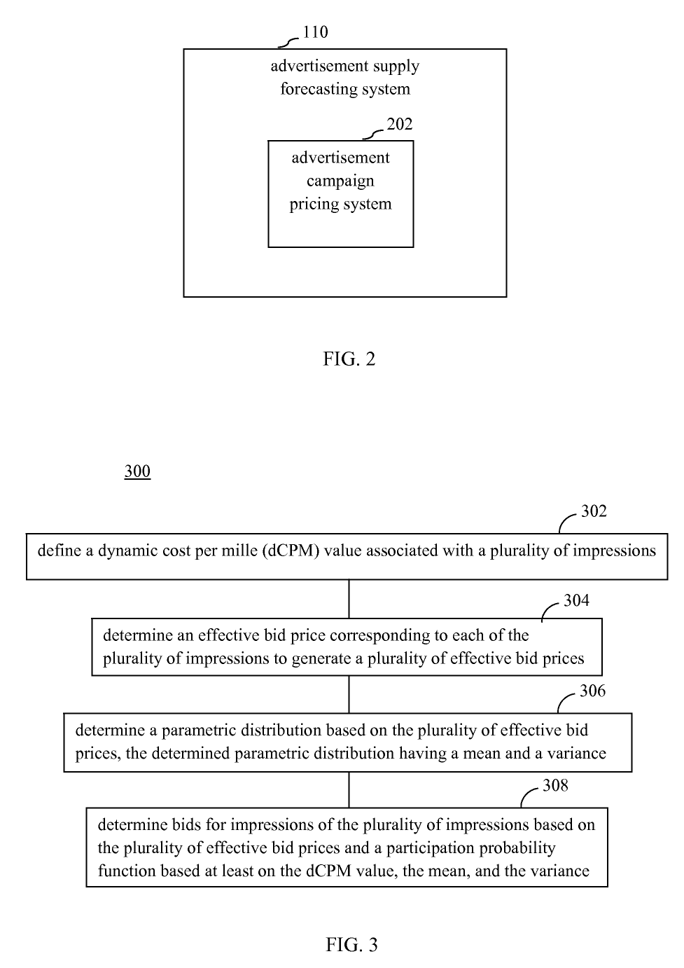

Advertisement supply forecasting system 110 may be implemented in various ways to forecast supply of impressions, in embodiments. For instance, FIG. 2 shows a block diagram of advertisement supply forecasting system 110, according to an example embodiment. As shown in FIG. 2, advertisement supply forecasting system 110 includes an advertisement campaign pricing system 202. Advertisement campaign pricing system 202 is configured to determine bid prices for impressions targeted by an advertisement campaign (e.g., as defined in a contract) in which a dCPM value is specified. In an embodiment, system 202 may model a distribution of the eCPM (effective cost per mille) values of a set of impressions of interest. System 202 is configured to calculate an auction participation probability and determine bid prices for each targeted impression based at least on the eCPM value. The bids may be determined in an order-independent manner, in contrast to prior techniques that are affected by an order in which impressions are priced. An average payout by the advertiser for the impressions is determined that is less than or equal to the specified dCPM price with a large probability.

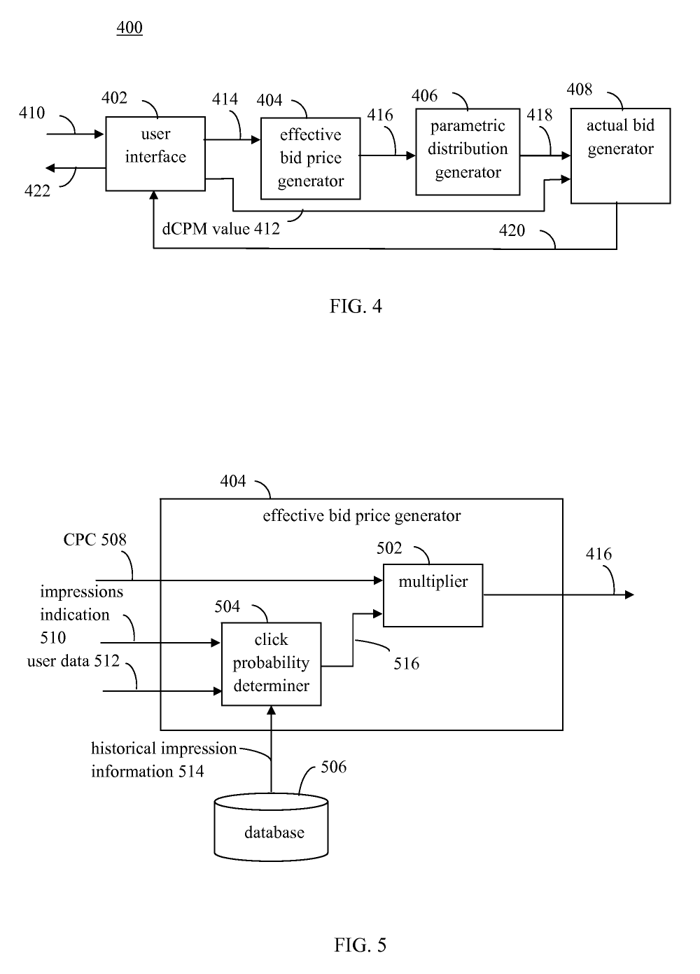

Advertisement campaign pricing system 202 is described as follows with respect to FIG. 3. FIG. 3 shows a flowchart 300 for pricing bids for impressions for an advertisement campaign, according to an example embodiment. In an embodiment, advertisement campaign pricing system 202 may operate according to flowchart 300. Flowchart 300 is described with respect to FIG. 4 for purposes of illustration. FIG. 4 shows a block diagram of an advertisement campaign pricing system 400, which is an example of system 202 of FIG. 2, according to an example embodiment. As shown in FIG. 2, advertisement supply pricing system 400 includes a user interface 402, an effective bid price generator 404, a parametric distribution generator 406, and an actual bid generator 408. Further structural and operational embodiments will be apparent to persons skilled in the relevant art(s) based on the discussion regarding flowchart 300. Flowchart 300 and advertisement campaign pricing system 400 are described as follows.

As shown in FIG. 3, flowchart 300 begins with step 302. In step 302, a dynamic cost per mille (dCPM) value is defined that is associated with a plurality of impressions. For instance, as shown in FIG. 4, user interface 402 receives a supply forecast request 410. Request 410 may be received from any type of requester, including an advertiser (e.g., advertiser system 108 of FIG. 1). Request 410 includes a contract that specifies parameters of the requested supply forecast. For instance, the contract may specify a dCPM value and a cost-per-metric value (e.g., CPC value or CPA value). The contract may indicate one or more target online properties (e.g., one or more websites, one or more particular web pages of a website, etc.) at which the requester may desire to display advertisements of an advertising campaign (e.g., a set of advertisements that share a theme to make up an integrated marketing communication). The target online properties may be indicated by website/webpage, by page location (e.g., North banner, rightside vertical, etc.), etc. The contract may further indicate one or more attributes associated with advertisement impressions at the indicated target online properties. Such attributes may include demographic attributes associated with a desired target audience, geographic attributes associated with a desired target audience, interests associated with a desired target audience, preferences associated with a desired target audience, and/or further types of attributes that may further define a desired target audience. Still further, the contract may indicate a target time period over which the impressions are desired—the duration of the advertising campaign—in terms of days or other measure of time.

Numerous types of attributes may be specified in a contract. Examples of demographic attributes that may be indicated in a contract include sex (male, female), age (e.g., specific ages, ranges of ages, age categories such as child, teenager, adult, etc.), income, education, employment status, etc. Examples of geographic attributes include present location, home address, home city, home state, home region, home country, etc. Examples of preference attributes include favorite foods, favorite travel destinations, favorite clothes, favorite items such as electronic gadgets, automobiles, etc. Examples of interest attributes include sports, cooking, travel, etc. Any number and combination of these and/or alternative attributes may be specified in a contract, including tens of attributes, hundreds of attributes, thousands of attributes, and even greater numbers of attributes.

User interface 402 may be implemented in any suitable manner to enable supply forecast requests/contracts to be received. For example, in an embodiment, user interface 402 may include a communication interface, such as described elsewhere herein or otherwise known, to receive request 410 in any form, including receiving request 410 as an email, as a text message, etc. In an embodiment, user interface 402 may provide a web page that enables a requester to enter information of request 410 into a fillable form or other graphical user interface. In another embodiment, user interface 402 may be implemented as a web service or other network-based application programming interface (API) configured to receive request 410.

As shown in FIG. 4, in response to receiving request 410, user interface 402 outputs impression data 414 and dCPM value 412. Impression data 414 includes an indication of the impressions (e.g., one or more target online properties and associated impression locations), the cost-per metric value, and the attributes indicated in the received contract, which includes demographic attributes, geographical attributes, etc.

Referring back to FIG. 3, in step 304, an effective bid price corresponding to each of the plurality of impressions is determined to generate a plurality of effective bid prices. For example, as shown in FIG. 4, effective bid price generator 404 receives impression data 414. In an embodiment, effective bid price (EBP) generator 404 is configured to generate an EBP for each of the impressions indicated in impression data 414. For instance, in an embodiment, the EBP may be calculated for an impression by multiplying the cost per-metric by a click probability determined for the impression.

For instance, FIG. 5 shows a block diagram of EBP generator 404, according to an example embodiment. As shown in FIG. 5, EBP generator 404 includes a multiplier 502 and a click probability determiner 504. As shown in FIG. 5, click probability determiner 504 receives impressions indication 510 and user data 512, which are included in impression data 414 (shown in FIG. 4). Impressions indication 510 indicates the impressions of interest to the requester indicated in impression data 414. User data 510 includes the attributes of users (demographic attributes, geographical attributes, etc.) that the requester desires to target.

Furthermore, as shown in FIG. 5, click probability determiner 504 receives historical impression information 514 from a database 506. Database 506 is a database that stores historical information about impressions, such as a list of impressions that were previously bid upon by advertisers, an indication of advertisements that were served for the previously bid upon impressions, and/or attributes of users associated with the previously bid upon impressions (e.g., attributes of the users to which the served advertisements were displayed). Click probability determiner 504 requests database 506 to provide historical impression information 514 for the impressions indicated in impressions indication 510. Historical impression information 514 includes the historical user attributes associated with the indicated impressions.

Click probability determiner 504 is configured to generate click probabilities for the impressions indicated in impressions indication 510 based on the user attributes included in user data 512. For instance, for each indicated impression, click probability determiner 504 may compare the user attributes included in user data 506 for the impression with the historical user attributes included in historical impression information 514 for the impression. If the user attributes of user data 506 match or are generally similar to the user attributes in historical impression information 514 for the impression (e.g., matching and/or similar demographics, matching and/or similar geographical attributes, etc.), the click probability for the impression may have a relatively high value (e.g., close to 1). If the user attributes of user data 506 do not match or are generally different the user attributes in historical impression information 514 for the impression (e.g., different demographics (e.g., different sex, age, etc.), different geographical attributes, etc.), the click probability for the impression may have a relatively low value (e.g., close to 0).

Click probability determiner 504 generates click probabilities 516, which includes the click probability generated for each impression. Multiplier 502 receives click probabilities 516 and CPC 508 (which is included in impressions data 414 of FIG. 4). For each impression, multiplier 502 is configured to multiply the value of CPC 508 by the click probability determined for the impression (included in click probabilities 516) to generate an effective bid price (e.g., an effective cost per mille value—eCPM). Multiplier 502 generates effective bid prices 416, which includes the effective bid prices generated for the impressions.

Note that in an alternative embodiment, a cost per action (CPA) value may be received instead of CPC 508, and may be used to generate the effective bid prices for the impressions.

Referring back to FIG. 3, in step 306, a parametric distribution is determined based on the plurality of effective bid prices, the determined parametric distribution having a mean and a variance. For example, referring to FIG. 4, parametric distribution generator 406 receives effective bid prices 416. In an embodiment, parametric distribution generator 406 may be configured to determine a parametric distribution based on effective bid prices 416, including determining a mean (an average effective bid price) and a variance for the parametric distribution.

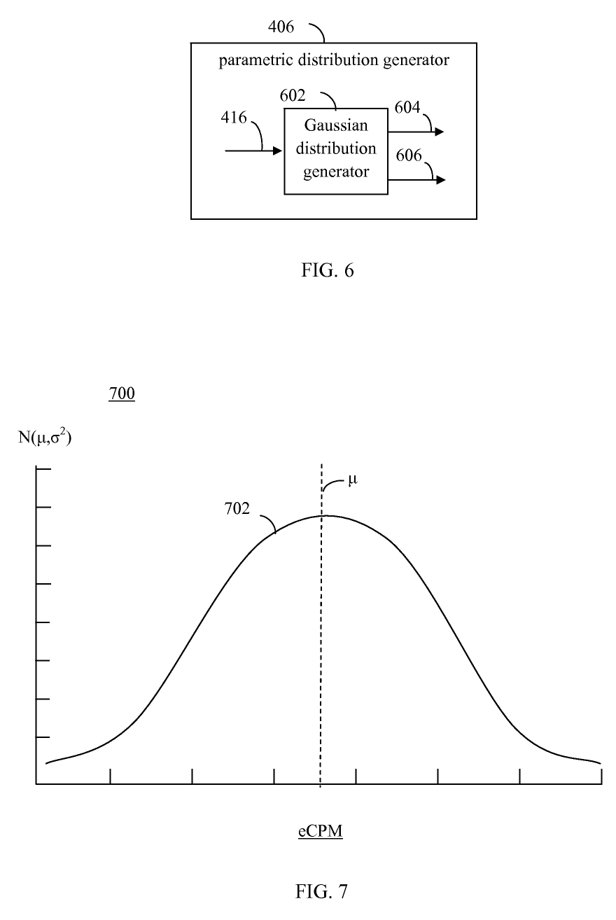

Parametric distribution generator 406 may be configured in various ways to generate a parametric distribution of one or more types. For instance, FIG. 6 shows a block diagram of parametric distribution generator 406 configured to generate a Gaussian distribution, according to an example embodiment. As shown in FIG. 6, parametric distribution generator 406 includes a Gaussian distribution generator 602. Gaussian distribution generator 602 may be configured to generate a Gaussian distribution based on effective bid prices 416. A Gaussian distribution is a continuous probability distribution that is often used as a first approximation to describe real-valued random variables that tend to cluster around a single mean value. The graph of the associated probability density function is “bell”-shaped, and is known as the Gaussian function or bell curve. A Gaussian distribution may be generated based on effective bid prices 416 in various ways, includes ways that are well known to persons skilled in the relevant art(s). Equation 1 shown below shows a Gaussian function f(x) for a variable x in equation form:

$$f ( x ) = \frac{1}{\sqrt{2 {πσ}^{2}}} {e}^{- \frac{{( x - μ )}^{2}}{2 {σ}^{2}}} \qquad Equation 1$$

where

μ=the mean, and

σ=the variance.

As shown in FIG. 6, Gaussian distribution generator 602 generates a mean 604 and a variance 606. Gaussian distribution generator 602 may generate (e.g., estimate) mean 604 and variance 606 in any manner, including by using maximum likelihood estimation, as would be known to persons skilled in the relevant art(s).

FIG. 7 shows a plot 700 of a Gaussian distribution 702, where eCPM (effective cost per mille) is the variable x (shown on the x-axis), according to an example embodiment. As shown in FIG. 7, plot Gaussian distribution has a bell shape.

Parametric distribution generator 406 of FIG. 4 may be configured to generate a Gaussian distribution, such as Gaussian distribution 702 shown in FIG. 7. As shown in FIG. 4, parametric distribution generator 406 generates parametric distribution information 418, which may include data and/or parameters such as mean 604 and variance 606 shown in FIG. 6 that describe the parametric (e.g., Gaussian) distribution.

Referring back to FIG. 3, in step 308, bids are determined for impressions of the plurality of impressions based on the plurality of effective bid prices and a participation probability function based at least on the dCPM value, the mean, and the variance. For example, as shown in FIG. 4, actual bid generator 408 receives parametric distribution information 418 and dCPM value 412. Actual bid generator 408 is configured to determine bids for the impressions indicated in impressions data 414 based on one or more of effective bid prices 416, mean 604, variance 606 (which may each be included in parametric distribution information 418), and dCPM value 412. As shown in FIG. 4, actual bid generator 408 generates bids 420, which includes bids for one or more of the impressions indicated in impressions data 414. For some impressions, it may have been decided to not place a bid, and in such case, bids 420 may not include bids for those impressions. In an embodiment, actual bid generator 408 may be configured to truncate the parametric distribution indicated by parametric distribution information 418 so that the parametric distribution does not extend outside of the range [0, 2dCPM]. In this manner, no bids are generated on impressions having effective bid prices outside of this range, and are not included in bids 420.

As shown in FIG. 4, bids 420 may be received by user interface 402, which enables the bids to be provided to the requester (that input request 410) in a response 422. User interface 402 may provide bids 420 to the requester in response 422 in any manner. For instance, a communication interface of user interface 402 may transmit response 422 to the requester in any form, including as an email, as a text message, etc. In an embodiment, user interface 402 may provide a web page that enables a requester to view response 422. In another embodiment, user interface 402 may be a web service or other network-based API that provides response 422 to the requester.

Actual bid generator 408 may be configured to generate bids 420 in various ways, in embodiments. In an embodiment, a parametric (e.g., Gaussian) distribution generated by parametric distribution generator 406 may be truncated by actual bid generator 408 into the range (0, 2dCPM), as there are no negative effective bid prices, and 2dCPM may be considered to be a maximum bid value. Instead of adjusting the bid price and always participating in an auction as described above for a conventional procedure, actual bid generator 408 may determine an auction participation probability for one or more impressions, and may bid the value of the determined effective bid price for an impression when the effective bid prices is in the range (0, 2dCPM).

In an embodiment, actual bid generator 408 may be configured to generate a bid for an impression using a first technique if dCPM is greater than or equal to (≧) mean 604, and may generate the bid for the impression using a second technique if dCPM is less than (<) mean 604. This is because it is desired to keep an average bid price to be less than dCPM, as described above. If the dCPM value of the campaign is greater than or equal to (≧) mean 604, the average bid price is less than the dCPM value, and the first technique may be used. If the dCPM value of the campaign is less than (<) mean 604, the average bid price is greater than the dCPM value, and as such, a participation probability for at least some of the impressions may be modified using the second technique to reduce the average bid price to be less than the dCPM value.

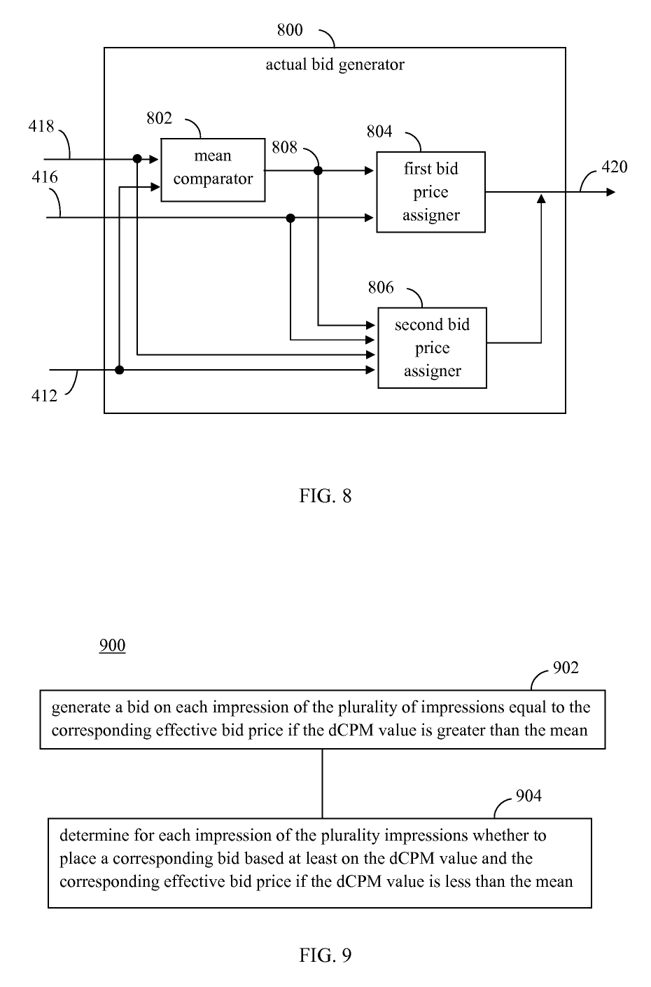

For instance, FIG. 8 shows a block diagram of an actual bid generator 800, according to an example embodiment. Actual bid generator 800 is an example of actual bid generator 408. As shown in FIG. 8, actual bid generator 800 includes a mean comparator 802, a first bid price assigner 804, and a second bid price assigner 806. Actual bid generator 800 is described as follows with respect to FIG. 9. FIG. 9 shows a flowchart 900 for determining a bid assignment technique, according to an example embodiment. In an embodiment, actual bid generator 800 may operate according to flowchart 900. Further structural and operational embodiments will be apparent to persons skilled in the relevant art(s) based on the discussion regarding flowchart 900. Flowchart 900 and actual bid generator 800 are described as follows.

As shown in FIG. 9, flowchart 900 begins with step 902. In step 902, a bid is generated on each impression of the plurality of impressions equal to the corresponding effective bid price if the dCPM value is greater than the mean. As shown in FIG. 8, mean comparator 802 receives dCPM value 412 and parametric distribution information 418, which includes mean 604. Mean comparator 802 is configured to compare dCPM value 412 to mean 604, and to generate an enable signal 808 based on the comparison. If mean comparator 802 determines that dCPM value 412 is greater than or equal to mean 604, mean comparator 802 generates enable signal 808 to have a first value to enable first bid price assigner 804 to assign actual bid values to each impression. For example, in an embodiment, if first bid price assigner 804 is enabled, first bid price assigner 804 may assign a bid value to each impression having the effective bid price value (of effective bid prices 416) generated for the impression.

In step 904, for each impression of the plurality impressions, it is determined whether to place a corresponding bid based at least on the dCPM value and the corresponding effective bid price if the dCPM value is less than the mean. For example, referring to FIG. 8, if mean comparator 802 determines that dCPM value 412 is less than mean 604, mean comparator 802 generates enable signal 808 to have a second value to enable second bid price assigner 806 to assign actual bid values to each impression. For instance, in an embodiment, second bid price assigner 806 may determine whether a bid is to be placed for each impression, and may assign a bid value to each impression, based on one or more of mean 604 and variance 606 (received in parametric distribution information 418), dCPM value 412, and effective bid prices 416. Second bid price assigner 806 may be configured to modify an auction participation profile to reduce the probability of bids being made on impressions in order to reduce the average bid price to be less than the dCPM value.

As shown in FIG. 8, first and second bid price assigners 804 and 806 output their generated bid prices for the impressions as bids 420 (depending on which of first and second bid price assigners 804 and 806 is enabled).

Example embodiments are described as follows for second bid price assigner 806, where dCPM value 412 is less than mean 604, and therefore an auction participation profile may be modified to reduce the probability of bids being made on impressions.

A. Bid Assignment Embodiments for a Campaign Having a dCPM Value that is Less than an Average Bid Price of the Campaign

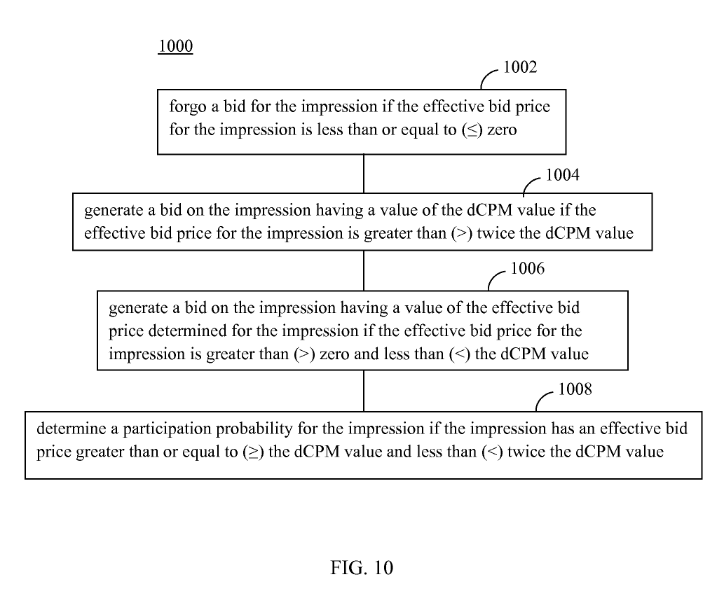

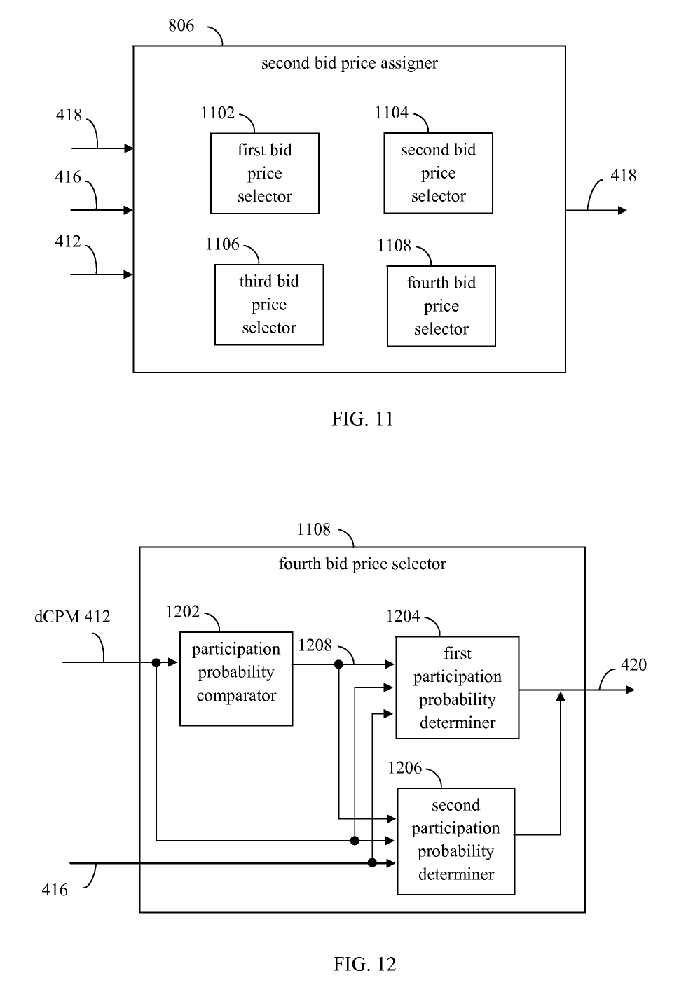

Second bid price assigner 806 may assign bid values to each impression in various ways. For instance, FIG. 10 shows a flowchart 1000 for assigning bids to impressions, according to an example embodiment. In an embodiment, second bid price assigner 806 may operate according to flowchart 1000. For instance, FIG. 11 shows a block diagram of second bid price assigner 806, according to an example embodiment. As shown in FIG. 11, second bid price assigner 806 includes a first bid price selector 1102, a second bid price selector 1104, a third bid price selector 1106, and a fourth bid price selector 1108. Further structural and operational embodiments will be apparent to persons skilled in the relevant art(s) based on the discussion regarding flowchart 1000 and second bid price assigner 806. Flowchart 1000 and second bid price assigner 806 are described as follows.

As shown in FIG. 11, second bid price assigner 806 receives dCPM value 412, effective bid prices 416 (which includes the effective bid prices generated for each of the impressions), and parametric distribution information 418 (which includes mean 604 and variance 606). Second bid price assigner 806 prices each impression separately to determine a bid price.

Flowchart 1000 may be performed for each impression of the set of targeted impressions (e.g., indicated in impressions indication 510 of FIG. 5), and may be performed on the impressions in any order, because flowchart 1000 is order-independent (the bid prices determined by flowchart 1000 do not depend on an order in which the impressions are processed). Referring to FIG. 10, flowchart 1000 begins with step 1002. In step 1002, a bid is not made for the impression if the effective bid price for the impression is less than or equal to (≦) zero. For example, as shown in FIG. 11, second bid price assigner 806 may compare the effective bid price of an impression to zero. If the effective bid price for the impression is less than or equal to (≦) zero, first bid price selector 1102 is enabled. In such case, first bid price selector 1102 assigns no bid price (e.g., a bid price of 0) to the impression. An indication of no bid price (e.g., a bid price of 0) is output by first bid price selector 1102 for the impression in bids 420.

In step 1004, a bid on the impression is generated having a value of the dCPM value if the effective bid price for the impression is greater than (>) twice the dCPM value. For example, as shown in FIG. 11, second bid price assigner 806 may compare the effective bid price of the impression to twice the dCPM value (2dCPM). If the effective bid price for the impression is greater than (>) twice the dCPM value, second bid price selector 1104 is enabled. In such case, second bid price selector 1104 assigns a bid price equal to dCPM value 412 to the impression. An indication of the bid price (e.g., a bid price of dCPM value 412) is output by second bid price selector 1104 for the impression in bids 420.

In step 1006, a bid on the impression is generated having a value of the effective bid price determined for the impression if the effective bid price for the impression is greater than (>) zero and less than (<) the dCPM value. For example, as described above, second bid price assigner 806 may compare the effective bid price of the impression to twice the dCPM value (2dCPM). If the effective bid price for the impression is greater than zero and less than the dCPM value, third bid price selector 1106 is enabled. In such case, third bid price selector 1106 assigns a bid price to the impression that is equal to the effective bid price (in effective bid prices 416) of the impression. An indication of the bid price (e.g., the effective bid price) is output by third bid price selector 1106 for the impression in bids 420.

In step 1008, a participation probability is determined for the impression if the impression has an effective bid price greater than or equal to (≧) the dCPM value and less than (<) twice the dCPM value. For example, second bid price assigner 806 may determine whether the effective bid price of the impression is in the range of between the dCPM value and twice the dCPM value (2dCPM). If the effective bid price for the impression is in this range, fourth bid price selector 1108 is enabled. In such case, fourth bid price selector 1108 is configured to assign a bid price to the impression that is equal to the effective bid price (in effective bid prices 416) of the impression. Furthermore, fourth bid price selector 1108 is configured to determine a participation probability for making the bid for the impression. An indication of the bid price (e.g., the effective bid price) and the determined participation probability for the impression is output by fourth bid price selector 1108 in bids 420.

The following subsection describes example embodiments for determining a participation probability for an impression having an effective bid price in the range of [dCPM, 2dCPM] according to step 1008.

(1) Bid Assignments for Impressions Having Effective Bid Prices in the Range of dCPM Value to Twice dCPM Value

Fourth bid price selector 1108 may be configured in various ways to determine a participation probability for an impression. For instance, in an embodiment, when mean 604 and variance 606 are generated for a Gaussian distribution, a cumulative distribution function (CDF) of the Gaussian distribution may be calculated that describes probabilities for a random variable to fall in the intervals of the form (−∞, x]. The CDF may be used to generate participation probabilities for impressions. The CDF Φ(x) of the Gaussian distribution is denoted by Equation 2 below:

$$Φ ( x ) = \frac{1}{\sqrt{2 {πσ}^{2}}} {\int }_{- ∞}^{x} exp \text{(} \frac{- {( t - μ )}^{2}}{2 {σ}^{2}} d t \qquad Equation 2$$

FIG. 12 shows a block diagram of fourth bid price selector 1108, according to an example embodiment. In FIG. 12, fourth bid price selector 1108 is configured to use the CDF to determine participation probabilities for impressions having effective bid prices in the range of between the dCPM value and twice the dCPM value. As shown in FIG. 12, fourth bid price selector 1108 includes a participation probability comparator 1202, a first participation probability determiner 1204, and a second participation probability determiner 1206. Fourth bid price selector 1108 of FIG. 12 is described as follows.

For impressions having an effective bid price greater than or equal to dCPM value 412, and less than 2dCPM, the campaign participates in the auction with some probability in order to have the average effective bid price (e.g., mean 602) that is less than dCPM value 412. However, if impressions with different effective bid prices are treated equally, a discontinuity in the bidding curve may occur. For example, the value of 2dCPM is bid for impressions with some probability, but a value over 2dCPM (2dCPM+ε) is not bid at all. dCPM value 412 is bid for impressions with a probability of 1, but a value over dCPM value 412 (dCPM+ε) is bid with some small probability. To avoid discontinuities due to these factors, in an embodiment, a linear approximation may be used to generate participation probabilities in the range of [dCPM, 2dCPM]. A participation probability of 1 is used at an effective bid price of dCPM value 412, and the participation probability is gradually decreased to 0 at an effective bid price of 2dCPM. Under this approximation, and assuming that effective bid prices are roughly uniformly distributed in range [dCPM, 2dCPM], the average participation probability is 0.5. Thus, when calculating a global average effective bid price, depending on the density of effective bid prices in the ranges of (0, dCPM) and [dCPM, 2dCPM], the average effective bid price may be larger or smaller than dCPM. If the average effective bid prices is larger than dCPM, an above average participation probability over 0.5 is compensated for by modifying the participation probability function.

As shown in FIG. 12, participation probability comparator 1202 receives dCPM value 412. Participation probability comparator 1202 is configured to determine a relative density of effective bid prices for impressions in the ranges (0, dCPM) and [dCPM, 2dCPM]. If (0, dCPM) has higher density relative to [dCPM, 2dCPM], first participation probability determiner 1204 is enabled by participation probability comparator 1202, and if (0, dCPM) has lower density relative to [dCPM, 2dCPM], second participation probability determiner 1206 is enabled by participation probability comparator 1202 (to provide compensation).

For instance, in an embodiment, participation probability comparator 1202 may evaluate Equation 3 below:

Φ(2dCPM)−Φ(dCPM)<2(Φ(dCPM)−Φ(0)) Equation 3

Equation 3 compares relative densities for (0, dCPM) and [dCPM, 2dCPM]. The factor 2 in the right hand side of Equation 3 compensates for the 0.5 average participation probability in the range [dCPM, 2dCPM] (due to the linear approximation described above that is used in this range).

According to Equation 3, if Φ(2dCPM)−Φ(dCPM) is less than 2(Φ(dCPM)−Φ(0)), participation probability comparator 1202 generates an enable signal 1208 to have a value that enables first participation probability determiner 1204. If Φ(2dCPM)−Φ(dCPM) is greater than or equal to 2(Φ(dCPM)−Φ(0)), participation probability comparator 1202 generates enable signal 1208 to have a value that enables second participation probability determiner 1206.

The following subsections describe participation probability modifications (e.g., due to linear approximation) that may be performed based on first participation probability determiner 1204 and second participation probability determiner 1206, respectively.

i. Participation Probability Function Modification for Lower Effective Bid Price Density in the Range of [dCPM, 2dCPM]

As shown in FIG. 12, first participation probability determiner 1204 receives enable signal 1208, dCPM 412, and effective bid prices 416. When first participation probability determiner 1204 is enabled, first participation probability determiner 1204 generates a campaign participation probability for the impression. For instance, in an embodiment, first participation probability determiner 1204 may generate the participation probability according to the linear approximation provided by Equation 4 shown below in the range (dCPM, 2dCPM) (where the effective bid price for the impression is an effective cost per mille (eCPM) value):

$$\frac{Φ ( 2 dCPM ) - ( eCPM )}{Φ ( 2 dCPM ) - ( dCPM )} \qquad Equation 4$$

The participation probability determined according to Equation 4 ranges from 1 (eCPM=dCPM) to 0 (eCPM=2dCPM). According to Equation 4, the final average eCPM for impressions is caused to be less than dCPM. For each impression having a participation probability calculated according to Equation 4, the calculated participation probability is included in bids 420 with the bid price (e.g., the effective bid price) for the impression.

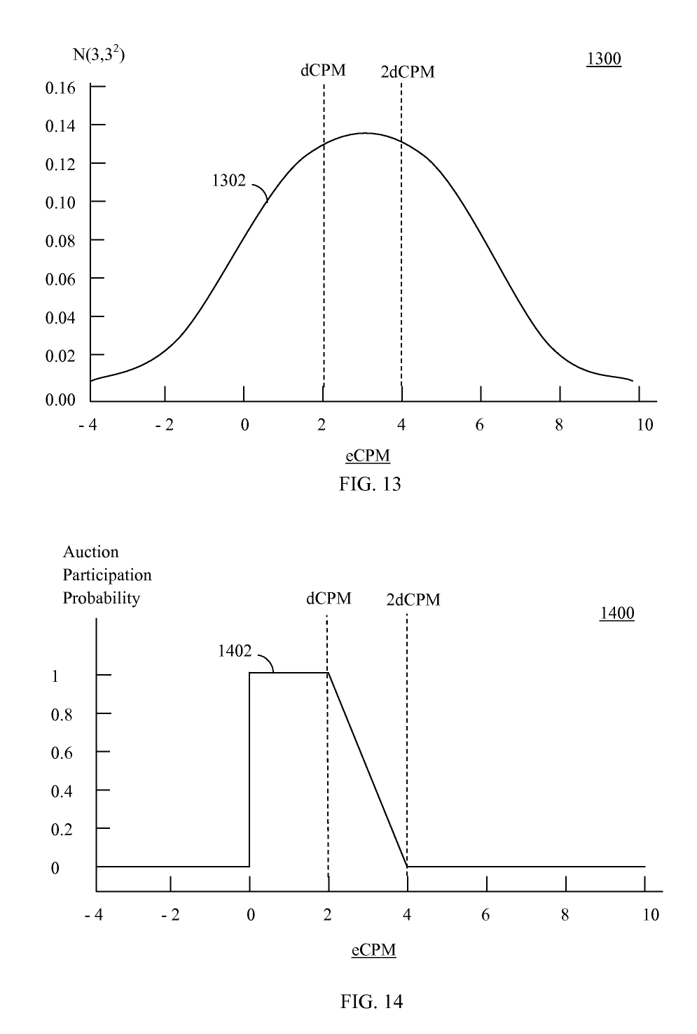

FIGS. 13 and 14 illustrate a Gaussian distribution and a participation probability function generated for an example campaign determined (e.g., according to Equation 3) to have a low enough density of impressions with effective bid prices in the range [dCPM, 2dCPM] to have an overall average effective bid price that is less than dCPM, and therefore including impressions that are processed according to first participation probability determiner 1204. FIG. 13 shows a plot 1300 of an example of a Gaussian distribution 1302 that may be generated by Gaussian distribution generator 602 (in step 306 of FIG. 3), according to an embodiment. FIG. 14 shows a plot 1400 of a corresponding auction participation probability function 1402, according to an example embodiment. In FIGS. 13 and 14, the effective bids prices determined for the impressions (in step 304 of FIG. 3) have the form of eCPM values (on the x-axes). In FIG. 14, participation probability function 1402 is modified in the range of [dCPM, 2dCPM] to have a final average effective bid price that is less than the dCPM value for the campaign.

In the example campaign corresponding to FIGS. 13 and 14, the dCPM value (set according to step 302 of FIG. 3) is 2. For Gaussian distribution 1302 in FIG. 13, the mean is 3 and the variance is 3 (as determined according to step 306 of FIG. 3). As shown in FIG. 14, auction participation probability function 1402 has a value of 0 for eCPM values less than 0 (due to step 1002 of FIG. 10) and for eCPM values greater than twice dCPM (e.g., due to truncation). As such, no bids are made in these ranges. Auction participation probability function 1402 has a value of 1 for eCPM values in the range of 0 to dCPM, and bids are made on impressions having eCPM values in this range using their eCPM values (due to step 1006 of FIG. 10). Auction participation probability function 1402 has values generated (in step 1008 of FIG. 1) according to the linear approximation of Equation 4 in the range of dCPM to 2dCPM. As shown in FIG. 14, function 1402 is linear from a probability of 1 to a probability of 0 in the range of dCPM to 2dCPM. Bids are made on impressions having eCPM values in this range using their eCPM values.

ii. Participation Probability Function Modification for Higher Effective Bid Price Density in the Range of [dCPM, 2dCPM]

As shown in FIG. 12, second participation probability determiner 1206 receives enable signal 1208, dCPM 412, and effective bid prices 416. When second participation probability determiner 1206 is enabled, second participation probability determiner 1206 generates a campaign participation probability for the impression.

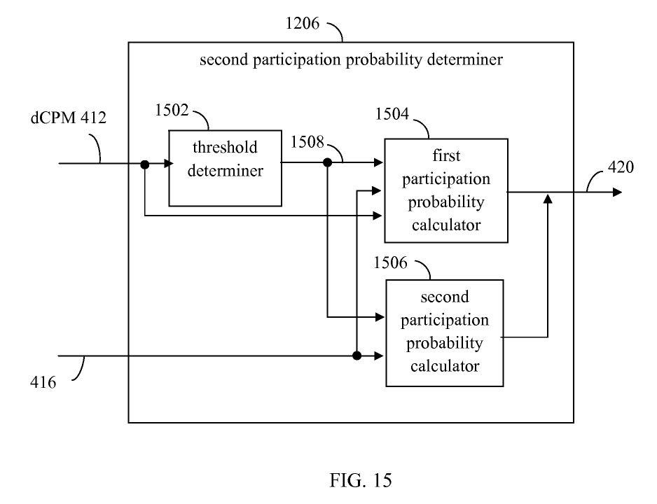

For instance, FIG. 15 shows a block diagram of second participation probability determiner 1206, according to an example embodiment. Second participation probability determiner 1206 of FIG. 15 is configured to generate a participation probability based on a threshold value. As shown in FIG. 15, second participation probability determiner 1206 includes a threshold determiner 1502, a first participation probability calculator 1504, and a second participation probability calculator 1506. Second participation probability determiner 1206 of FIG. 15 is described as follows.

As shown in FIG. 15, threshold determiner 1502 receives dCPM 412. Threshold determiner 1502 is configured to generate a threshold value 1508 in the range of [dCPM, 2dCPM] based on dCPM value 412. For impressions having an effective bid price value that is less than the threshold value 1508, first participation probability calculator 1504 generates the participation probability for the impression according to a linear approximation technique. For impressions having an effective bid price value that is greater than or equal to the threshold value T, second participation probability calculator 1506 generates the participation probability for the impression.

For instance, in an embodiment, threshold determiner 1502 may solve Equation 5 shown below for threshold T to determine threshold value 1508 (where the effective bid price for the impression is an effective cost per mille (eCPM) value):

Φ(T)−Φ(dCPM)≧2(Φ(dCPM)−Φ(0)) Equation 5

As shown in FIG. 15, first participation probability calculator 1504 receives threshold value 1508, dCPM 412, and effective bid prices 416. If the effective bid price (in effective bid prices 416) for the impression is less than threshold value 1508 in the range of [dCPM, 2dCPM], first participation probability calculator 1504 generates a campaign participation probability for the impression. For instance, in an embodiment, first participation probability calculator 1504 may generate the participation probability according to the linear approximation provided by Equation 6 shown below in the range (dCPM, T):

$$\frac{Φ ( T ) - Φ ( EBP )}{Φ ( T ) - Φ ( dCPM )} \qquad Equation 6$$

The participation probability determined according to Equation 6 ranges from 1 (T=EBP) to 0 (eCPM=dCPM). According to Equation 6, the final average eCPM is caused to be less than dCPM. For each impression having a participation probability calculated according to Equation 6, the calculated participation probability is included in bids 420 with the bid price (e.g., the effective bid price) for the impression.

As shown in FIG. 12, second participation probability calculator 1506 receives threshold value 1508 and effective bid prices 416. If the effective bid price (in effective bid prices 416) for the impression is greater than or equal to threshold value 1508 (and less than 2dCPM), second participation probability calculator 1506 determines the campaign participation probability for the impression to be zero. The determined participation probability of zero is included in bids 420 with the bid price (e.g., the effective bid price) for the impression by second participation probability calculator 1506.

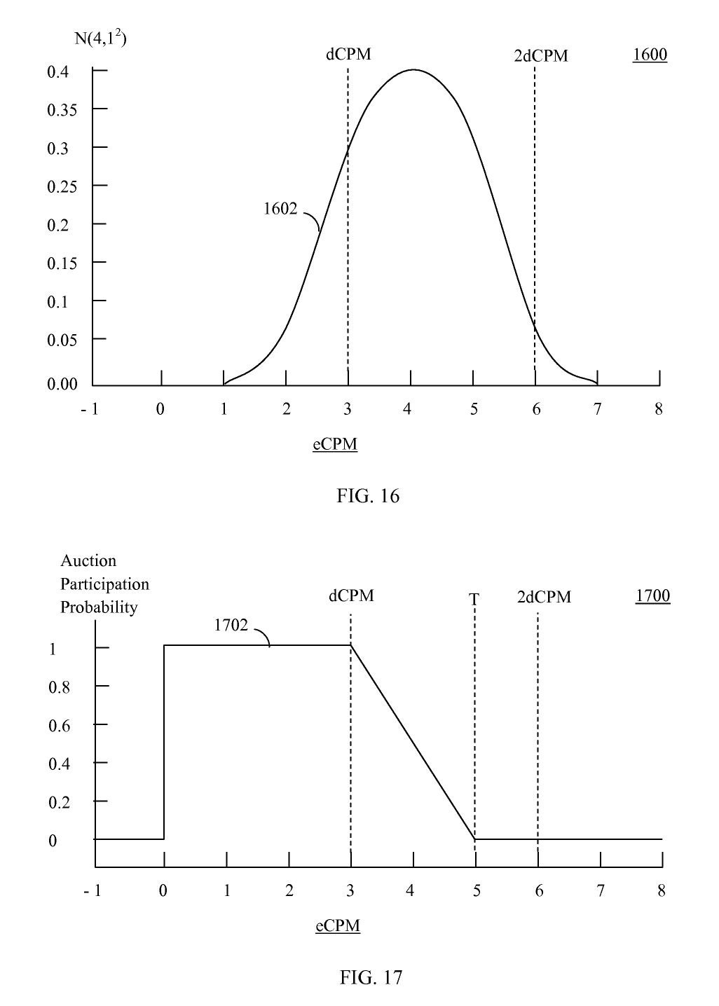

FIGS. 16 and 17 illustrate a Gaussian distribution and a participation probability function generated for an example campaign determined (e.g., according to Equation 3) to have a high enough density of impressions with effective bid prices in the range [dCPM, 2dCPM] to have an overall average effective bid price that is greater than dCPM, even with a 0.5 average participation probability provided in the range of [dCPM, 2dCPM] by linear approximation. As such, impressions of this campaign are processed according to second participation probability determiner 1206. FIG. 16 shows a plot 1600 of an example of a Gaussian distribution 1602 that may be generated by Gaussian distribution generator 602 (in step 306 of FIG. 3), according to an embodiment. FIG. 17 shows a plot 1700 of a corresponding auction participation probability function 1702, according to an example embodiment. In FIGS. 16 and 17, the effective bids prices determined for the impressions (in step 304 of FIG. 3) have the form of eCPM values (on the x-axes). In FIG. 17, participation probability function 1702 is modified in the ranges of [dCPM, T] and [T, 2dCPM] to have a final average effective bid price that is less than the dCPM value for the campaign.

In the example campaign corresponding to FIGS. 16 and 17, the dCPM value (set according to step 302 of FIG. 3) is 3. For Gaussian distribution 1602 in FIG. 13, the mean is 4 and the variance is 1 (as determined according to step 306 of FIG. 3). As shown in FIG. 17, auction participation probability function 1702 has a value of 0 for eCPM values less than 0 (due to step 1002 of FIG. 10) and for eCPM values greater than twice dCPM (e.g., due to truncation). As such, no bids are made in these ranges. Auction participation probability function 1702 has a value of 1 for eCPM values in the range of 0 to dCPM, and bids are made on impressions having eCPM values in this range using their eCPM values (due to step 1006 of FIG. 10). Threshold value T is determined to have a value of 5 (e.g., by solving Equation 5 for T). Auction participation probability function 1702 has values generated (in step 1008 of FIG. 1) according to the linear approximation of Equation 6 in the range of [dCPM, T]. As shown in FIG. 17, function 1702 is linear from a probability of 1 to a probability of 0 in the range of [dCPM, T]. Bids are made on impressions having eCPM values in this range using their eCPM values. Auction participation probability function 1702 has a value of 0 for eCPM values in the range of [T, 2dCPM].

### IV. Example Computer Implementations

Advertisement supply forecasting system 110, advertisement campaign pricing system 202, advertisement campaign pricing system 400, user interface 402, effective bid price generator 404, parametric distribution generator 406, actual bid generator 408, multiplier 502, click probability determiner 504, Gaussian distribution generator 602, actual bid generator 800, mean comparator 802, first bid price assigner 804, second bid price assigner 806, first bid price selector 1102, second bid price selector 1104, third bid price selector 1106, fourth bid price selector 1108, participation probability comparator 1202, first participation probability determiner 1204, second participation probability determiner 1206, threshold determiner 1502, first participation probability calculator 1504, second participation probability calculator 1506, flowchart 300, flowchart 900, and flowchart 1000 may be implemented in hardware, software, firmware, or any combination thereof. For example, advertisement supply forecasting system 110, advertisement campaign pricing system 202, advertisement campaign pricing system 400, user interface 402, effective bid price generator 404, parametric distribution generator 406, actual bid generator 408, multiplier 502, click probability determiner 504, Gaussian distribution generator 602, actual bid generator 800, mean comparator 802, first bid price assigner 804, second bid price assigner 806, first bid price selector 1102, second bid price selector 1104, third bid price selector 1106, fourth bid price selector 1108, participation probability comparator 1202, first participation probability determiner 1204, second participation probability determiner 1206, threshold determiner 1502, first participation probability calculator 1504, second participation probability calculator 1506, flowchart 300, flowchart 900, and/or flowchart 1000 may be implemented as computer program code configured to be executed in one or more processors. Alternatively, advertisement supply forecasting system 110, advertisement campaign pricing system 202, advertisement campaign pricing system 400, user interface 402, effective bid price generator 404, parametric distribution generator 406, actual bid generator 408, multiplier 502, click probability determiner 504, Gaussian distribution generator 602, actual bid generator 800, mean comparator 802, first bid price assigner 804, second bid price assigner 806, first bid price selector 1102, second bid price selector 1104, third bid price selector 1106, fourth bid price selector 1108, participation probability comparator 1202, first participation probability determiner 1204, second participation probability determiner 1206, threshold determiner 1502, first participation probability calculator 1504, second participation probability calculator 1506, flowchart 300, flowchart 900, and/or flowchart 1000 may be implemented as hardware logic/electrical circuitry.

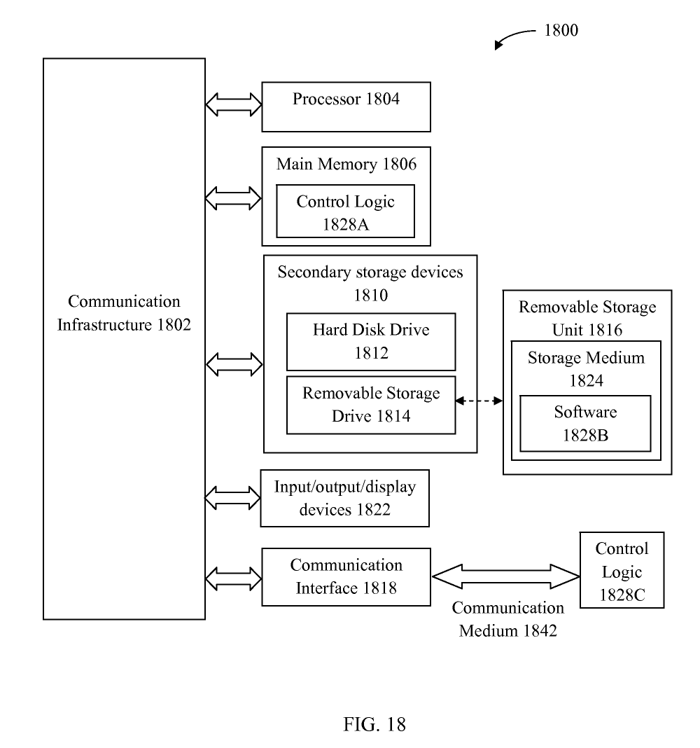

The embodiments described herein, including systems, methods/processes, and/or apparatuses, may be implemented using well known servers/computers, such as a computer 1800 shown in FIG. 18. For example, user systems 102a-102m, publisher servers 104a-104n, advertiser system 108, and/or embodiments of advertisement serving system 106 can be implemented using one or more computers 1800.

Computer 1800 can be any commercially available and well known computer capable of performing the functions described herein, such as computers available from International Business Machines, Apple, Sun, HP, Dell, Cray, etc. Computer 1800 may be any type of computer, including a desktop computer, a server, etc.

Computer 1800 includes one or more processors (also called central processing units, or CPUs), such as a processor 1804. Processor 1804 is connected to a communication infrastructure 1802, such as a communication bus. In some embodiments, processor 1804 can simultaneously operate multiple computing threads.

Computer 1800 also includes a primary or main memory 1806, such as random access memory (RAM). Main memory 1806 has stored therein control logic 1828A (computer software), and data.

Computer 1800 also includes one or more secondary storage devices 1810. Secondary storage devices 1810 include, for example, a hard disk drive 1812 and/or a removable storage device or drive 1814, as well as other types of storage devices, such as memory cards and memory sticks. For instance, computer 1800 may include an industry standard interface, such a universal serial bus (USB) interface for interfacing with devices such as a memory stick. Removable storage drive 1814 represents a floppy disk drive, a magnetic tape drive, a compact disk drive, an optical storage device, tape backup, etc.

Removable storage drive 1814 interacts with a removable storage unit 1816. Removable storage unit 1816 includes a computer useable or readable storage medium 1824 having stored therein computer software 1828B (control logic) and/or data. Removable storage unit 1816 represents a floppy disk, magnetic tape, compact disk, DVD, optical storage disk, or any other computer data storage device. Removable storage drive 1814 reads from and/or writes to removable storage unit 1816 in a well known manner.

Computer 1800 also includes input/output/display devices 1822, such as monitors, keyboards, pointing devices, etc.

Computer 1800 further includes a communication or network interface 1818. Communication interface 1818 enables the computer 1800 to communicate with remote devices. For example, communication interface 1818 allows computer 1800 to communicate over communication networks or mediums 1842 (representing a form of a computer useable or readable medium), such as LANs, WANs, the Internet, etc. Network interface 1818 may interface with remote sites or networks via wired or wireless connections.

Control logic 1828C may be transmitted to and from computer 1800 via the communication medium 1842.

Any apparatus or manufacture comprising a computer useable or readable medium having control logic (software) stored therein is referred to herein as a computer program product or program storage device. This includes, but is not limited to, computer 1800, main memory 1806, secondary storage devices 1810, and removable storage unit 1816. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like.

As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for advertisement supply forecasting system 110, advertisement campaign pricing system 202, advertisement campaign pricing system 400, user interface 402, effective bid price generator 404, parametric distribution generator 406, actual bid generator 408, multiplier 502, click probability determiner 504, Gaussian distribution generator 602, actual bid generator 800, mean comparator 802, first bid price assigner 804, second bid price assigner 806, first bid price selector 1102, second bid price selector 1104, third bid price selector 1106, fourth bid price selector 1108, participation probability comparator 1202, first participation probability determiner 1204, second participation probability determiner 1206, threshold determiner 1502, first participation probability calculator 1504, second participation probability calculator 1506, flowchart 300, flowchart 900, and/or flowchart 1000 (including any one or more steps of flowcharts 300, 900, and 1000), and/or further embodiments of the present invention described herein. Embodiments of the invention are directed to computer program products comprising such logic (e.g., in the form of program code or software) stored on any computer useable medium. Such program code, when executed in one or more processors, causes a device to operate as described herein.

The invention can work with software, hardware, and/or operating system implementations other than those described herein. Any software, hardware, and operating system implementations suitable for performing the functions described herein can be used.

### IV. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of forecasting an advertisement campaign for an advertiser, comprising:
defining a dynamic cost per mille (dCPM) value associated with a plurality of impressions;
determining an effective bid price corresponding to each of the plurality of impressions to generate a plurality of effective bid prices;
determining a parametric distribution based on the plurality of effective bid prices, the determined parametric distribution having a mean and a variance; and
determining bids for impressions of the plurality of impressions based on the plurality of effective bid prices and a participation probability function based at least on the dCPM value, the mean, and the variance.

2. The method of claim 1, wherein said determining bids for impressions of the plurality of impressions based on the plurality of effective bid prices and a participation probability function based at least on the dCPM value, mean, and variance comprises:
generating a bid on each impression of the plurality of impressions equal to the corresponding effective bid price if the dCPM value is greater than the mean; and
determining for each impression of the plurality impressions whether to place a corresponding bid based at least on the dCPM value and the corresponding effective bid price if the dCPM value is less than the mean.

3. The method of claim 2, wherein said determining for each impression of the plurality impressions whether to place a corresponding bid based at least on the dCPM value and the effective bid price comprises:
for each impression of the plurality impressions,
forgoing a bid for the impression if the effective bid price for the impression is less than or equal to (≦) zero,
generating a bid on the impression having a value of the dCPM value if the effective bid price for the impression is greater than (>) twice the dCPM value,
generating a bid on the impression having a value of the effective bid price determined for the impression if the effective bid price for the impression is greater than (>) zero and less than (<) the dCPM value, and
determining a participation probability for the impression if the impression has an effective bid price greater than or equal to (≧) the dCPM value and less than (<) twice the dCPM value.

4. The method of claim 3, wherein said determining a participation probability for each impression having an effective bid price greater than or equal (≧) the dCPM value and less than twice the dCPM value comprises
for each impression of the plurality impressions having an effective bid price greater than or equal (≧) the dCPM value and less than (<) twice the dCPM value:
if Φ(2dCPM)−Φ(dCPM)<2(Φ(dCPM)−Φ(0)), determining the participation probability for the impression according to
$$\frac{Φ ( 2 dCPM ) - Φ ( EBP )}{Φ ( 2 dCPM ) - Φ ( dCPM )} ,$$
where
EBP=the effective bid price for the impression, and
Φ(X)=a value of a cumulative distribution function of a Gaussian distribution based on the mean and the variance for a value of X; and
if Φ(2dCPM)−Φ(dCPM)≧2(Φ(dCPM)−Φ(0)),
determining a threshold value T by solving Φ(T)−Φ(dCPM)=2(Φ(dCPM)−Φ(0)),
determining the participation probability for the impression according to
$$\frac{Φ ( T ) - Φ ( EBP )}{Φ ( T ) - Φ ( dCPM )}$$
if the effective bid price for the impression is less than (<) T, and
determining the participation probability for the impression to be zero if the effective bid price for the impression is greater than or equal to (≧) T.

5. The method of claim 1, wherein said determining an effective bid price corresponding to each of the plurality of impressions to generate a plurality of effective bid prices comprises:
determining an effective cost per mille (eCPM) for each of the plurality of impressions to be the effective bid price for each of the plurality of impressions.

6. The method of claim 1, wherein said determining an effective bid price corresponding to each of the plurality of impressions to generate a plurality of effective bid prices comprises:
calculating an effective bid price for an impression by multiplying a cost per-metric by click probability for the impression.

7. The method of claim 6, wherein the cost per-metric is a cost per click (CPC) value or a cost per action (CPA) value.

8. An advertisement campaign pricing system, comprising:
an effective bid price generator configured to determine an effective bid price corresponding to each of a plurality of impressions to generate a plurality of effective bid prices;
a parametric distribution generator configured to determine a parametric distribution based on the plurality of effective bid prices, the determined parametric distribution having a mean and a variance; and
an actual bid generator configured to determine bids for impressions of the plurality of impressions based on the plurality of effective bid prices and a participation probability function based at least on a dynamic cost per mille (dCPM) value associated with the plurality of impressions, the mean, and the variance.

9. The advertisement campaign pricing system of claim 8, wherein if the dCPM value is greater than the mean, the actual bid generator is configured to generate a bid on each impression of the plurality of impressions equal to the corresponding effective bid price; and
if the dCPM value is less than the mean, the actual bid generator is configured to determine for each impression of the plurality impressions whether to place a corresponding bid based at least on the dCPM value and the corresponding effective bid price.

10. The advertisement campaign pricing system of claim 9, wherein if the dCPM value is less than the mean, for each impression of the plurality impressions, the actual bid generator does not determine a bid for the impression if the effective bid price for the impression is less than or equal to (≦) zero, generates a bid on the impression having a value of the dCPM value if the effective bid price for the impression is greater than (>) twice the dCPM value, generates a bid on the impression having a value of the effective bid price determined for the impression if the effective bid price for the impression is greater than (>) zero and less than (<) the dCPM value, and determines a participation probability for the impression if the impression has an effective bid price greater than or equal (≧) the dCPM value and less than (<) twice the dCPM value.

11. The advertisement campaign pricing system of claim 10, wherein if the dCPM value is less than the mean, for each impression of the plurality impressions having an effective bid price greater than or equal to (≧) the dCPM value and less than (<) twice the dCPM value:
if Φ(2dCPM)−Φ(dCPM)<2(Φ(dCPM)−Φ(0)), the actual bid generator determines the participation probability for the impression according to
$$\frac{Φ ( 2 dCPM ) - Φ ( EBP )}{Φ ( 2 dCPM ) - Φ ( dCPM )} ,$$
where
EBP=the effective bid price for the impression, and
Φ(X)=a value of a cumulative distribution function of a Gaussian distribution based on the mean and the variance for a value of X; and
if Φ(2dCPM)−Φ(dCPM)≧2(Φ(dCPM)−Φ(0)), the actual bid generator determines a threshold value T by solving Φ(T)−Φ(dCPM)=2(Φ(dCPM)−Φ(0)), determines the participation probability for the impression according to
$$\frac{Φ ( T ) - Φ ( EBP )}{Φ ( T ) - Φ ( dCPM )}$$
if the effective bid price for the impression is less than (<) T, and determines the participation probability for the impression to be zero if the effective bid price for the impression is greater than or equal to (≧) T.

12. The advertisement campaign pricing system of claim 8, wherein the effective bid price generator is configured to determine an effective cost per mille (eCPM) for each of the plurality of impressions to be the effective bid price for each of the plurality of impressions.

13. The advertisement campaign pricing system of claim 8, wherein the effective bid price generator is configured to calculate an effective bid price for an impression by multiplying a cost per-metric by click probability for the impression.

14. The advertisement campaign pricing system of claim 13, wherein the cost per-metric is a cost per click (CPC) value or a cost per action (CPA) value.

15. A computer program product comprising a computer-readable medium having computer program logic recorded thereon for enabling a processor to forecast an advertisement campaign for an advertiser, comprising:
first computer program logic means for enabling the processor to determine an effective bid price corresponding to each of a plurality of impressions to generate a plurality of effective bid prices;
second computer program logic means for enabling the processor to determine a parametric distribution based on the plurality of effective bid prices, the determined parametric distribution having a mean and a variance; and
third computer program logic means for enabling the processor to determine bids for impressions of the plurality of impressions based on the plurality of effective bid prices and a participation probability function based at least on a dynamic cost per mille (dCPM) value associated with the plurality of impressions, the mean, and the variance.

16. The computer program product of claim 15, wherein the third computer program logic means comprises:
fourth computer program logic means for enabling the processor to generate a bid on each impression of the plurality of impressions equal to the corresponding effective bid price if the dCPM value is greater than the mean; and
fifth computer program logic means for enabling the processor to determine for each impression of the plurality impressions whether to place a corresponding bid based at least on the dCPM value and the corresponding effective bid price if the dCPM value is less than the mean.

17. The computer program product of claim 16, wherein the fifth computer program logic means comprises:
sixth computer program logic means for enabling the processor to forgo a bid for an impression if the effective bid price for the impression is less than or equal to (≦) zero,
seventh computer program logic means for enabling the processor to generate a bid on the impression having a value of the dCPM value if the effective bid price for the impression is greater than (>) twice the dCPM value,
eighth computer program logic means for enabling the processor to generate a bid on the impression having a value of the effective bid price determined for the impression if the effective bid price for the impression is greater than (>) zero and less than (<) the dCPM value, and
ninth computer program logic means for enabling the processor to determine a participation probability for the impression if the impression has an effective bid price greater than or equal to (≧) the dCPM value and less than (<) twice the dCPM value.

18. The computer program product of claim 17, wherein the ninth computer program logic means comprises:
tenth computer program logic means for enabling the processor to determine the participation probability for the impression according to
$$\frac{Φ ( 2 dCPM ) - Φ ( EBP )}{Φ ( 2 dCPM ) - Φ ( dCPM )}$$
if Φ(2dCPM)−Φ(dCPM)<2(Φ(dCPM)−Φ(0)),
where
EBP=the effective bid price for the impression, and
Φ(X)=a value of a cumulative distribution function of a Gaussian distribution based on the mean and the variance for a value of X; and
eleventh computer program logic means for enabling the processor to, if Φ(2dCPM)−Φ(dCPM)≧2(Φ(dCPM)−Φ(0)), determine a threshold value T by solving Φ(T)−Φ(dCPM)=2(Φ(dCPM)−Φ(0)), determine the participation probability for the impression according to
$$\frac{Φ ( T ) - Φ ( EBP )}{Φ ( T ) - Φ ( dCPM )}$$
it the effective bid price for the impression is less than (<) T, and determine the participation probability for the impression to be zero if the effective bid price for the impression is greater than or equal to (≧) T.

19. The computer program product of claim 15, wherein the first computer program logic means comprises:
computer program logic means for enabling the processor to determine an effective cost per mille (eCPM) for each of the plurality of impressions to be the effective bid price for each of the plurality of impressions.

20. The computer program product of claim 15, wherein the first computer program logic means comprises:
computer program logic means for enabling the processor to calculate an effective bid price for an impression by multiplying a cost per-metric by click probability for the impression.
